(19) United States
(12) Patent Application Publication
(10) Pub. No.: US 2012/0239827 A1
(43) Pub. Date: Sep. 20, 2012

(54) Communication Device Based on USB Interface and Method for Implementing Service Configuration

(75) Inventors: Daming Lu, Shenzhen City (CN); Shengjin Pang, Shenzhen City (CN); Kaixuan Li, Shenzhen City (CN); Hongli Wang, Shenzhen City (CN); Cuiling Lu, Shenzhen City (CN)

(73) Assignee: ZTE CORPORATION, Shenzhen City, GD (CN)

(21) Appl. No.: 13/258,520

(22) PCT Filed: Jun. 18, 2010
(86) PCT No.: PCT/CN10/74097

§ 371 Date: Feb. 6, 2012

(30) Foreign Application Priority Data
Dec. 8, 2009 (CN) 200910242297.1

(51) Int. Cl. G06F 3/00

(52) U.S. Cl. 710/10; 710/8

(57) ABSTRACT

A communication device based on a USB interface and a method for implementing service configuration are provided. The method is used for the communication device based on the USB interface, comprising: said communication device based on the USB interface reporting a device descriptor to a host, thus making said host complete loading of a host driver; said communication device based on the USB interface receiving a control instruction sent from the host side through the USB interface; and said communication device based on the USB interface configuring service attribute information according to said control instruction, so as to enable said service attribute information to indicate service attributes of said communication device based on the USB interface. The USB control information controls the service attribute information such that said device can implement support to service differentiation aiming at different operating systems.

### TECHNICAL FIELD

The present invention relates to the filed of communication, and in particular, to a communication device based on a USB interface and a method for implementing service configuration.

### BACKGROUND OF THE RELATED ART

Currently, the user's requirements on the access terminal of a mobile broadband, for example the requirements for a data card and an Integrated Access Device (IAD) having a wireless access function increase day by day with the development of mobile broadband. With regard to a data card, a user wishes that it can be used not only on a PC (Personal Computer) but also as a wireless access module in an IAD, thereby achieving maximum utilization of resources. Meanwhile, since operators have different operating policies, the service function of a data card when used on a PC is different from its function when used on an IAD. For example, when a data card is used on a PC, the operator only wishes it to focus on data services; while when it is used on an IAD, the operator wishes it to have not only data services but also circuit-switched (CS) voice functions.

On another hand, since different PCs use different operating systems, for example, the mainstream operating systems include WINDOWS system, MAC OS and LINUX systems, and service attributes of a data card when used in various systems are also different, therefore, the service types to be supported are also different for different operating systems.

However, the existing data card cannot implement different service types according to the types of the hosts or different operating system environments of the hosts.

The defect existing in the prior art are only described above by taking a data card as an example, and other communication devices based on a USB interface also have the same defect.

### SUMMARY OF THE INVENTION

In order to solve the problem of how a communication device based on a USB interface implement different service attributes in different environments, the present invention provides a method for implementing service configuration used for a communication device based on a USB interface, comprising:

said communication device based on the USB interface reporting a device descriptor to a host, thus making said host complete loading of a host driver;

said communication device based on the USB interface receiving a control instruction sent from a host side through the USB interface; and

said communication device based on the USB interface configuring service attribute information according to said control instruction, so as to enable said service attribute information to indicate service attributes of said communication device based on the USB interface.

Said step of configuring service attribute information comprises:

said communication device based on the USB interface analyzing said control instruction; and

said communication device based on the USB interface initializing said service attribute information according to information obtained after analyzing said control instruction to complete configuration of said service attribute information.

After said step of configuring service attribute information, said method further comprises:

said communication device based on the USB interface receiving service;

said communication device based on the USB interface judging whether said service is supported according to said service attribute information, if yes, executing said service; if no, executing said service abnormally.

After said step of receiving the control instruction sent from the host side, said method further comprises:

said communication device based on the USB interface sending a response message to said host side.

Said host side is a host driver or a user application program.

The present invention also provides a communication device based on a USB interface, comprising:

a sending module configured to report a device descriptor to a host to make said host complete loading of a host driver;

a first receiving module configured to receive a control instruction sent from the host side through the USB interface after said host driver has been loaded; and

a configuring module configured to configure service attribute information according to said control instruction.

Said configuring module comprises:

an analyzing unit configured to analyze said control instruction; and

an initializing unit configured to initialize said service attribute information according to information obtained after analyzing said control instruction to complete configuration of said service attribute information.

Said communication device further comprises:

a responding module configured to send a response message to said host side after said first receiving module receives said control instruction.

Said communication device further comprises:

a second receiving module configured to receiving service;

a judging module configured to judge whether said service is supported according to said service attribute information; and

a service executing module configured to execute said service when said judging module judges that said service is supported, and execute said service abnormally when said judging module judges that said service is not supported.

Said communication device based on the USB interface is a data card.

Compared with the prior art, the present invention has the following beneficial effects:

In the present invention, a user controls the service attribute information through the USB control information, including the service attributes applicable to the current system, sent from the host side, such that the device of the present invention initializes the service attribute information according to the USB control information, thereby enabling the device of the present invention to implement support to service differentiation aiming at different operating systems. Specifically, a user uses the same data card to meet requirements for use both on a PC and an IAD. In addition, the USB control instruction is sent through loading of a host driver according to the present invention, and no other additional operation is required for a User Interface (UI) of a third party or an IAD, so integration is much easier.

### BRIEF DESCRIPTION OF DRAWINGS

FIG. 1 is a structural schematic diagram of the device according to the present invention;

FIG. 2 is a structural schematic diagram of the configuring module;

FIG. 3 is a flow chart of initializing a service control table according to the present invention;

FIG. 4 is a flow chart of processing at the called side during a voice call according to the present invention;

FIG. 5 is a flow chart of processing at the calling side during a voice call according to the present invention.

### PREFERRED EMBODIMENTS OF THE INVENTION

As for devices based on a USB interface and interacting with a PC such as a data card, a method is required to be provided to enable it to have different service attributes when used in different environments. Taking a data card as an example, the present invention provides a device and a method for implementing indication of service attributes in a data card through a USB control instruction and thereby implementing service control.

The specific embodiments of the present invention will be further described in detail with reference to attached drawings below.

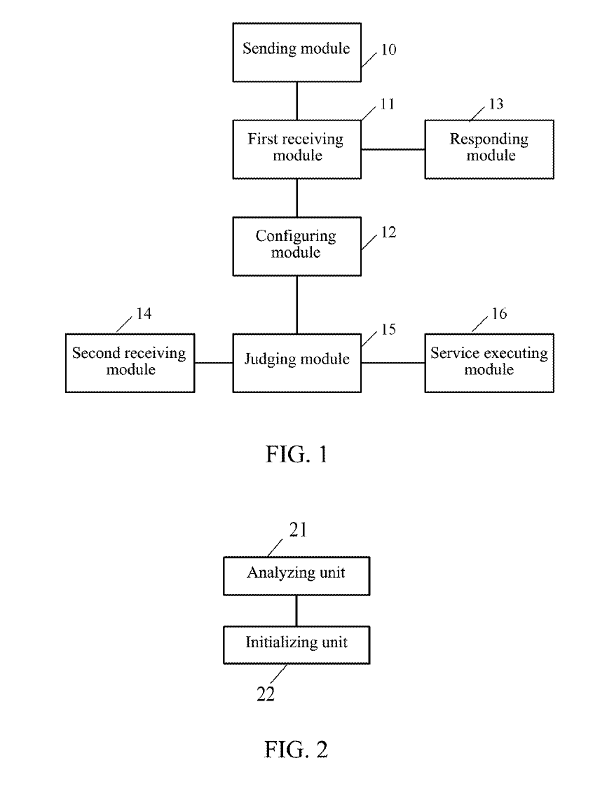

Referring to FIG. 1, FIG. 1 is a structural schematic diagram of the device according to the present invention, wherein the device comprises:

a sending module 10 used to report a device descriptor to a host to make said host complete loading of a host driver according to the device descriptor;

the host driver refers to the host driver of a USB controller at the host side, and it is an interface between an operating system and an operating and controlling USB device. The device descriptor includes: Process Identifier (PID), Voltage Identification (VID) and configuration descriptor.

A first receiving module 11 used to receive a control instruction sent from the host side upon completion of loading;

The first receiving module 11 receives a control instruction sent from the host side through a USB control end-point of the USB interface. The control instruction includes indication of types of services that can be provided, for example, the control instruction may be in the form of a character string, and 1 is defined as voice service, 2 is defined as data service, and 0 is defined as being able to provide the service, then 01 indicates being able to provide voice service, and 02 indicates being able to provide data service. Or, 0 may be defined as not providing the service, then 01 indicates not providing voice service, and 02 indicates not providing data service.

Of course, other modes that can be accepted by both parties of communication can also be used to configure the control instruction.

The host side herein may be both a host driver and a user application program on a host.

A configuring module 12 used to configure service attribute information according to the control instruction.

Service attribute information can be represented in the form of a service control table, or in other forms, and service attribute information indicates types of services that can be supported by the communication device based on the USB interface and related information. The device and method for implementing service configuration will be described below in detail by taking a service control table as an example.

Furthermore, the device of the present invention further comprises: a responding module 13 used to send a response message to the host side after the first receiving module 11 receives the control instruction.

The above module completes configuration of the service control table, and after the service control table is completely configured, specific service processing process will be executed. Therefore, the device of the present invention further comprises: a second receiving module 14, a judging module 15 and a service executing module 16.

The second receiving module 14 is used to receiving service;

the judging module 15 is used to judge whether said service is supported according to the service control table;

when the judging module 15 implements judging function, it can send an inquiry message to the configuring module 12 to inquire whether the service is stored in the service control table, and the configuring module 12 feeds back an inquiry result to the judging module 15. There are two kinds of inquiry results: the service being supported if the service is stored in the service control table, and the service being not supported if the service is not stored in the service control table.

The service executing module 16 is used to execute the service when the judging module 15 obtains information that the service is supported, otherwise, execute the service abnormally.

Referring to FIG. 2, FIG. 2 is a structural schematic diagram of the configuring module, wherein the configuring module specifically comprises:

an analyzing unit 21 used to analyze the control instruction; and

an initializing unit 22 used to initialize the service control table that is stored in advance according to information obtained after analyzing the control instruction to complete configuration of the service control table.

The analyzed control instruction is service configuration information.

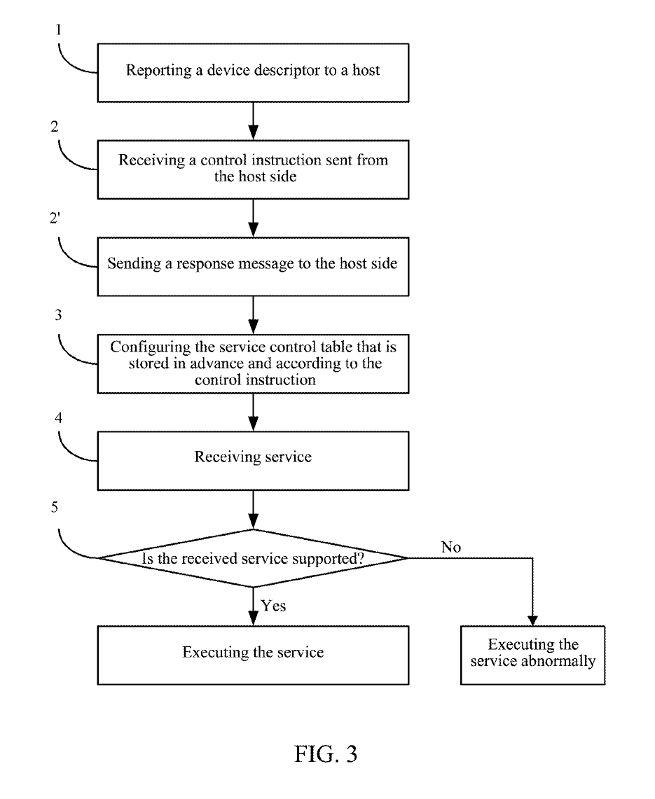

Referring to FIG. 3, FIG. 3 is a flow chart of initializing a service control table according to the present invention, comprising the following steps of:

Step 1, reporting a device descriptor to a host, thus making the host complete loading of a host driver;

The device descriptor includes: PID, VID and configuration descriptor.

Step 2, receiving a control instruction sent by the host side;

The control instruction sent by the host side can be received through a control end-point of USB. The host side is a host driver or a user application program on the host. The control instruction includes indication of the types of services that can be provided, for example, the control instruction may be in the form of a character string, and 1 is defined as voice service, 2 is defined as data service, and 0 is defined as being able to provide the service, then 01 indicates being able to provide voice service, and 02 indicates being able to provide data service. Or, 0 may be defined as not providing the service, then 01 indicates not providing voice service, and 02 indicates not providing data service.

Step 3, configuring the service control table that is stored in advance according to the control instruction.

Furthermore, after step 2, further comprising:

Step 2′, sending a response message to the host side.

The process of initializing the service control table is completed by the above steps, thereby completing the configuration of the service control table. After completion of configuration, if service is accessed, whether to execute the service will be judged according to the service control table, which is specifically as follows:

Step 4, receiving service;

Step 5, judging whether the received service is supported or not according to the service control table, and if yes, executing the service, otherwise executing the service abnormally.

Operation of executing the service abnormally is: for example, if an ATD command is received, an ERROR message is directly returned when the service is not supported.

When step 5 is specifically carried out, inquiry can be performed in the service control table to judge whether the received service exists in the service control table, if yes, the received service is executed.

The process of specifically executing the initiated service after configuration of the service control table will be described below in detail with reference to two examples.

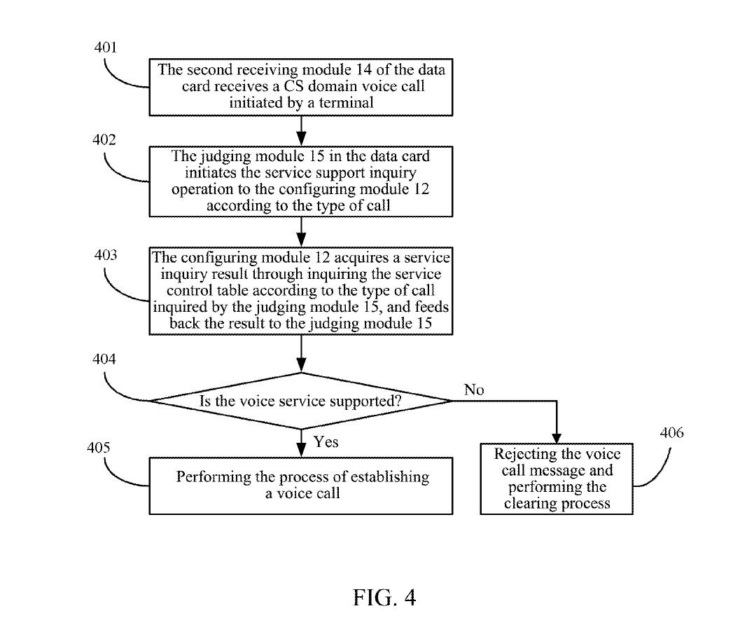

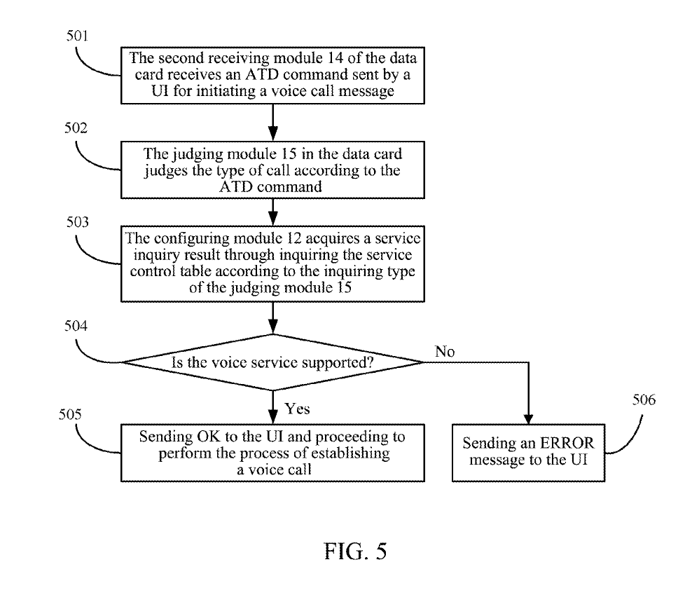

Referring to FIG. 4, FIG. 4 is a flow chart of processing at the called side during a voice call according to the present invention, comprising the following steps of:

Step 401, the second receiving module 14 of the data card receiving a CS domain voice call initiated by a terminal;

Step 402, the judging module 15 in the data card initiating service support inquiry operation to the configuring module 12 according to the type of call;

Step 403, the configuring module 12 acquiring a service inquiry result through inquiring the service control table according to the type of call inquired by the judging module, and feeding back the result to the judging module 15;

Step 404, the judging module 15 judging whether voice service is supported or not according to the inquiry result fed back by the configuring module, and if voice service is supported, executing step 405; otherwise, executing step 406;

Step 405, the service executing module 16 performing the process of establishing a voice call;

Step 406, the service executing module 16 rejecting the voice call message and performing the clearing process.

Referring to FIG. 5, FIG. 5 is a flow chart of processing at the calling side during a voice call according to the present invention, comprising the following steps of:

Step 501, the second receiving module 14 of the data card receiving an ATD command sent by an UI for initiating a voice call message;

Step 502, the judging module 15 in the data card judging the type of call according to the ATD command, and if it is voice service, such as a CS domain voice call, then inquiring to the configuring module 12 whether a voice call is supported or not;

if it is judged that the type of service is other service such as a CS domain data call, a Packet Switch (PS) domain data call and a short message, inquiring to the configuring module 12 whether the corresponding type of service is supported or not in the same manner as the CS domain voice call.

Step 503, the configuring module 12 acquiring a service inquiry result through inquiring the service control table according to inquiring type of the judging module 15, and feeding back the result to the judging module 15;

Step 504, the judging module 15 judging whether voice service is supported or not according to the inquiry result fed back by the configuring module 12, and if voice service is supported, executing step 505; otherwise, executing step 506;

Step 505, the service executing module 16 sending OK to the UI and proceeding to perform the process of establishing a voice call; otherwise, executing step 506;

Step 506, the service executing module 16 sending an ERROR message to the UI.

The above examples are only preferred embodiments of the present invention. It should be pointed out that several improvements and modifications can be made to the present invention by the person skilled in the art without departing from the principle of the present invention, and these improvements and modifications should be also construed as within the protection scope of the present invention.

### INDUSTRIAL APPLICABILITY

In the present invention, a user controls the service attribute information through the USB control information, including the service attributes applicable to the current system, sent from the host side, such that the device of the present invention initializes the service attribute information according to the USB control information, thereby enabling the device of the present invention to implement support to service differentiation aiming at different operating systems.

What is claimed is:

1. A method for implementing service configuration, characterized in that the method is used for a communication device based on a USB interface and comprises:
said communication device based on the USB interface reporting a device descriptor to a host, thus making said host complete loading of a host driver;
said communication device based on the USB interface receiving a control instruction sent from a host side through the USB interface; and
said communication device based on the USB interface configuring service attribute information according to said control instruction, so as to enable said service attribute information to indicate service attributes of said communication device based on the USB interface.

2. The method according to claim 1, wherein the step of configuring said service attribute information comprises:
said communication device based on the USB interface analyzing said control instruction; and
said communication device based on the USB interface initializing said service attribute information according to information obtained after analyzing said control instruction to complete configuration of said service attribute information.

3. The method according to claim 1, wherein, after the step of configuring said service attribute information, the method further comprises:
said communication device based on the USB interface receiving service;
said communication device based on the USB interface judging whether said service is supported according to said service attribute information, and if yes, executing said service; if no, executing said service abnormally.

4. The method according to claim 1, wherein, after the step of receiving the control instruction sent from the host side, the method further comprises:
said communication device based on the USB interface sending a response message to said host side.

5. The method according to claim 1, wherein said host side is the host driver or a user application program.

6. A communication device based on a USB interface, comprising:
a sending module configured to report a device descriptor to a host to make said host complete loading of a host driver;
a first receiving module configured to receive a control instruction sent from a host side through the USB interface after said host driver has been loaded; and
a configuring module configured to configure service attribute information according to said control instruction.

7. The communication device according to claim 6, wherein said configuring module comprises:
an analyzing unit configured to analyze said control instruction; and
an initializing unit configured to initialize said service attribute information according to information obtained after analyzing said control instruction to complete configuration of said service attribute information.

8. The communication device according to claim 6, further comprising:
a responding module configured to send a response message to said host side after said first receiving module receives said control instruction.

9. The communication device according to claim 6, further comprising:
a second receiving module configured to receiving service;
a judging module configured to judge whether said service is supported according to said service attribute information; and
a service executing module configured to execute said service when said judging module judges that said service is supported, and execute said service abnormally when said judging module judges that said service is not supported.

10. The communication device according to claim 6, wherein said communication device is a data card.
